(19) United States
(12) Patent Application Publication
(10) Pub. No.: US 2007/0182417 A1
(43) Pub. Date: Aug. 9, 2007

(54) ELECTRICAL MEASUREMENT OF CELL INVASION

(76) Inventors: Ivar Giaever, Schenectady, NY (US); Charles R. Keese, Schoharie, NY (US)

Correspondence Address: HOFFMAN WARNICK & D'ALESSANDRO, LLC, 75 STATE STREET, 14TH FLOOR, ALBANY, NY, 12207, US

(21) Appl. No.: 11/670,480

(22) Filed: Feb. 2, 2007

Related U.S. Application Data
(60) Provisional application No. 60/764,989, filed on Feb. 3, 2006.

(51) Int. Cl. G01N 27/416; G01N 27/00

(52) U.S. Cl. 324/426; 324/71.1

(57) ABSTRACT

The electrical measurement of invasive cell movement is provided. A gel layer is added to a well including a substrate having an electrode thereon. A medium is added over the gel layer. One of the medium and the gel layer can include cells and the other of the medium and the gel layer can comprise a compound to be evaluated for its influence on cell migration. An electrical signal is applied to the electrode and a property (e.g., impedance) of the electrical signal is measured. By analyzing the property, it can be determined whether and to what extent cells are in contact with the electrode. An influence of the compound on cell migration can be correlated with the property.

### REFERENCE TO PRIOR APPLICATIONS

The current application claims the benefit of co-pending U.S. Provisional Application No. 60/764,989, entitled “Cell invasion measurement”, which was filed on 3 Feb. 2006, and which is hereby incorporated herein by reference.

### FIELD OF THE INVENTION

Aspects of the invention relate generally to measuring cells, and more particularly, to a solution for electrically measuring invasive movement of cells.

### BACKGROUND OF THE INVENTION

Invasion assays are commonly used in tissue culture to determine an ability of cells to penetrate a gel. For example, a typical cell invasion assay may include a membrane containing pores and coated with a solid gel, which contains basement membrane proteins. Cells in suspension, such as mammalian cells or endothelial cells (important in angiogenesis), are loaded over the coated membrane. Since the gel blocks the membrane pores, non invasive cells remain on the upper side of the membrane. However, invasive cells will migrate into the gel layer and through the membrane appearing on the opposite side.

Various approaches are used to detect the invasive cells, and thereby determine whether or not migration has taken place and to what degree. For example, after a period of time, cells that did not pass through the membrane's pores can be removed and cells on the other side of the membrane can be stained and observed microscopically. Alternatively, cells can be labeled with fluorescent compounds, which are used to detect the invasive cells that pass through the gel-blocked pores of the membrane.

Cell behavior, such as morphology changes and cell motions in animal cells that attach and spread out and crawl on the bottom of tissue culture vessels, can be monitored using electrical sensing. For example, as shown and described in U.S. Pat. No. 5,187,096, which is hereby incorporated by reference, cell behavior can be passively analyzed by applying a weak alternating current (AC) electric current across one or more electrodes with which cell(s) may come in contact. In particular, cells can be grown on an electrode mounted to a bottom of a small well, and a much larger counter electrode can complete an electrical circuit. A standard tissue culture medium can be used as an electrolyte. For monitoring, a weak (e.g., approximately 1 microampere) AC current (usually in the frequency range from 100 to 40,000 Hertz) is applied to the system.

In addition to monitoring cell behavior, electricity can be used to wound cells. For example, as shown and described in the co-pending U.S. patent application Ser. No. 10/163,322, titled “Electrical wounding assay for cells in vitro”, which was filed on 5 Jun. 2002, and which is hereby incorporated by reference, a high pulse of current can be applied to wound cells in contact with an electrode. In this case, the wounding pulse of current can last for a few seconds, have a current of approximately a few milliamperes that results in a voltage drop of approximately 1 volt across the cell layer, and when an AC current is used, a frequency within a range of frequencies between 10,000 and 60,000 Hertz. Additionally, a shorter wounding pulse of current (e.g., 200 milliseconds) can be used to electroporate the cells allowing a cytotoxic agent to permeate and kill the cell(s).

### BRIEF SUMMARY OF THE INVENTION

Aspects of the invention provide a solution for the electrical measurement of invasive cell movement. A gel layer is added to a well including a substrate having an electrode thereon. A medium is added over the gel layer. One of the medium and the gel layer can include cells and the other of the medium and the gel layer can comprise a compound to be evaluated for its influence on cell migration. An electrical signal is applied to the electrode and a property (e.g., impedance) of the electrical signal is measured. By analyzing the property, it can be determined whether and to what extent cells are in contact with the electrode. An influence of the compound on cell migration can be correlated with the property.

A first aspect of the invention provides a method of electrically measuring invasive cell movement, the method comprising: adding cells over a first gel layer in a well, the well including a substrate having an electrode; applying an electrical signal to the electrode; and measuring at least one property of the electrical signal.

A second aspect of the invention provides a method of electrically measuring invasive cell movement, the method comprising: adding a medium over a first gel layer and cells in a well, the well including a substrate having an electrode; applying an electrical signal to the electrode; and measuring at least one property of the electrical signal.

A third aspect of the invention provides a method of electrically evaluating an influence of a compound on cell migration, the method comprising: adding a medium over a gel layer in a first well, the first well including a substrate having an electrode, one of the medium and the gel layer including cells and the other of the medium and the gel layer including the compound; applying an electrical signal to the electrode; and measuring at least one property of the electrical signal.

A fourth aspect of the invention provides a system for electrically evaluating an influence of a compound on cell migration, the system comprising: a well including a substrate having an electrode, and including a sample therein, the sample including a gel layer and a medium over the gel layer, one of the medium and the gel layer including cells and the other of the medium and the gel layer including the compound; a system for applying an electrical signal to the electrode; and a system for measuring at least one property of the electrical signal.

A fifth aspect of the invention provides a computer program comprising program code stored on a computer-readable medium, which when executed, enables a computer system to implement a method of electrically evaluating an influence of a compound on cell migration, the method comprising: applying an electrical signal to an electrode, the electrode included on a substrate in a well having a sample therein, the sample including a gel layer and a medium over the gel layer, one of the medium and the gel layer including cells and the other of the medium and the gel layer including the compound; and measuring at least one property of the electrical signal.

The illustrative aspects of the invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention.

FIG. 1 shows an illustrative environment for obtaining electronic measurement data according to an embodiment of the invention.

FIG. 2 shows a more detailed view of an illustrative measurement apparatus according to an embodiment of the invention.

FIGS. 3A-C show a series of cross-sectional views of a well during an illustrative experiment to electrically measure the invasive movement of cells according to an embodiment of the invention.

FIG. 4 shows a chart for an illustrative experiment according to an embodiment of the invention.

FIGS. 5A-C show a series of cross-sectional views of a well during another illustrative experiment to electrically measure the invasive movement of cells according to another embodiment of the invention.

FIG. 6 shows a pair of charts for another illustrative experiment according to an embodiment of the invention.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a solution for the electrical measurement of invasive cell movement. A gel layer is added to a well including a substrate having an electrode thereon. A medium is added over the gel layer. One of the medium and the gel layer can include cells and the other of the medium and the gel layer can comprise a compound to be evaluated for its influence on cell migration. An electrical signal is applied to the electrode and a property (e.g., impedance) of the electrical signal is measured. By analyzing the property, it can be determined whether and to what extent cells are in contact with the electrode. An influence of the compound on cell migration can be correlated with the property. As used herein, unless otherwise noted, the term “set” means one or more (i.e., at least one) and the phrase “any solution” means any now known or later developed automated, semi-automated, or manual solution.

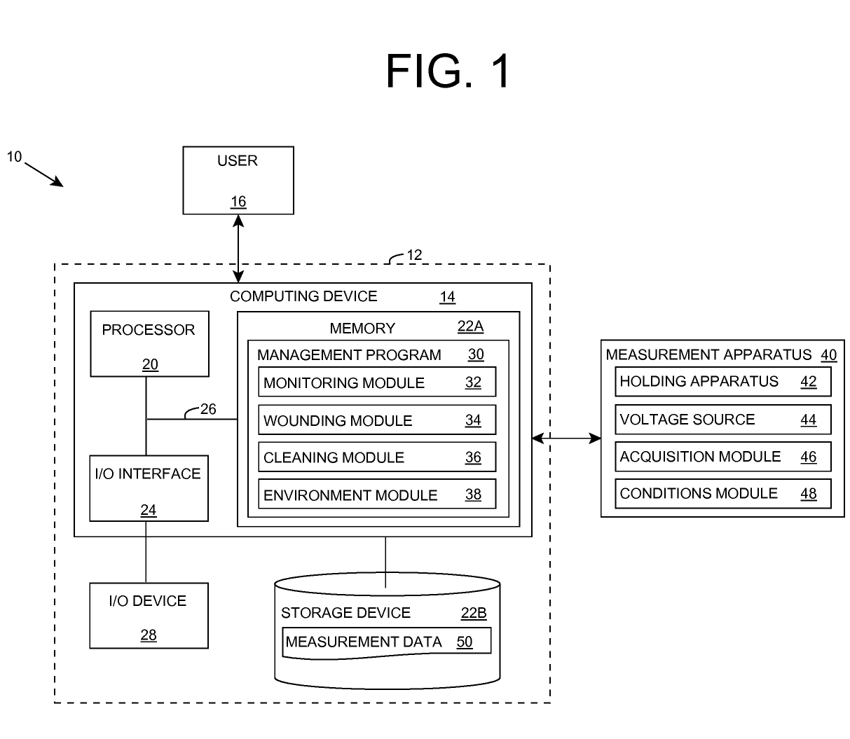

Turning to the drawings, FIG. 1 shows an illustrative environment 10 (e.g., electronic measurement system) for managing electronic measurement data 50 according to an embodiment of the invention. To this extent, environment 10 includes a computer system 12 that can perform the processes described herein in order to manage an electronic measurement apparatus 40 and measurement data 50. In particular, computer system 12 is shown including a computing device 14 that comprises a management program 30, which makes computing device 14 operable to obtain measurement data 50 using measurement apparatus 40 and manage measurement data 50 by performing the processes described herein.

Computing device 14 is shown including a processor 20, a memory 22A, an input/output (I/O) interface 24, and a bus 26. Further, computing device 14 is shown in communication with an external I/O device/resource 28 and a storage device 22B. In general, processor 20 executes program code, such as management program 30, which is at least partially stored in a storage system, such as memory 22A and/or storage device 22B. While executing program code, processor 20 can read and/or write data, such as measurement data 50, to/from memory 22A, storage device 22B, and/or I/O interface 24. Bus 26 provides a communications link between each of the components in computing device 14, while I/O interface 24 provides a communications link between computing device 14 and one or more I/O devices 28. I/O device 28 can comprise any device that transfers data between a user 16 and computing device 14. To this extent, I/O device 28 can comprise a human-usable I/O device to enable an individual user 16 to interact with computing device 14 and/or a communications I/O device to enable another system, such as measurement apparatus 40 and/or a system user 16, to communicate with computing device 14 using any type of communications link.

In any event, computing device 14 can comprise any general purpose computing article of manufacture capable of executing program code installed thereon. However, it is understood that computing device 14 and management program 30 are only representative of various possible equivalent computing devices that may perform the process described herein. To this extent, in other embodiments, the functionality provided by computing device 14 and management program 30 can be implemented by a computing article of manufacture that includes any combination of general and/or specific purpose hardware and/or program code. In each embodiment, the program code and hardware can be created using standard programming and engineering techniques, respectively.

Similarly, computer system 12 is only illustrative of various types of computer systems for implementing aspects of the invention. For example, in one embodiment, computer system 12 comprises two or more computing devices that communicate over any type of communications link to perform the processes described herein. Further, while performing the processes described herein, one or more computing devices in computer system 12 can communicate with one or more other computing devices external to computer system 12 using any type of communications link. In either case, each communications link can comprise any combination of various types of wired and/or wireless links; comprise any combination of one or more types of networks; and/or utilize any combination of various types of transmission techniques and protocols. Additionally, it is understood that some or all of the functions discussed herein can be manually implemented, without the use of computer system 12.

In any event, management program 30 obtains measurement data 50 from measurement apparatus 40. Management program 30 can manage measurement data 50 using any solution. For example, measurement data 50 can be stored as one or more files in a file system, which can define various objects/structures that can be manipulated (e.g., modified, added, deleted, etc.) in a dynamic memory using management program 30 and subsequently stored in the one or more files. Similarly, measurement data 50 can be stored in a relational database or the like. Additionally, management program 30 can enable user 16 to request action(s) to be performed on measurement data 50. To this extent, management program 30 can generate a user interface for display to a human user 16, which enables user 16 to obtain, view, modify, delete, and/or the like measurement data 50. Further, management program 30 can define an application program interface (API) or the like that enables similar functionality for a system user 16.

In general, management program 30 enables computer system 12 to manage measurement apparatus 40 and obtain measurement data 50 acquired using measurement apparatus 40. To this extent, management program 30 is shown including a monitoring module 32, a wounding module 34, a cleaning module 36, and an environment module 38. Each module can operate one or more components in measurement apparatus 40 to obtain measurement data 50. Measurement apparatus 40 can include a holding apparatus 42, a voltage source 44, an acquisition module 46, and a conditions module 48.

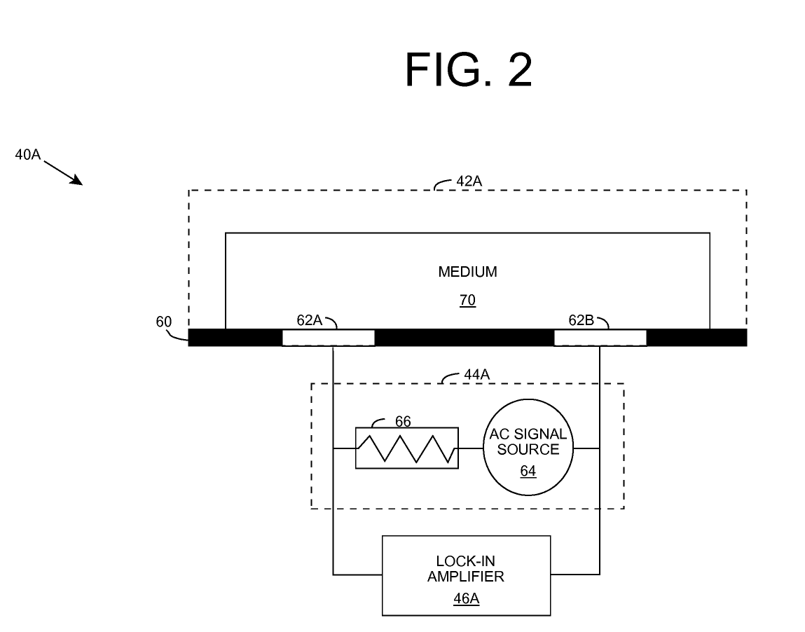

Management program 30 (and/or a human user 16) operates one or more components of measurement apparatus 40 to obtain measurement data 50. FIG. 2 shows a more detailed view of an illustrative measurement apparatus 40A according to an embodiment of the invention. Holding apparatus 42A includes one or more containers (e.g., wells), each of which includes a substrate 60 with a set of electrodes 62A-B mounted thereon, and can hold a medium 70 thereon. Electrode(s) 62A-B are electrically connected to a voltage source 44A, which is shown including an AC signal source 64 and a resistor 66. In operation, voltage source 44A applies an AC current through resistor 66 and electrode 62A. Current then flows through medium 70 and (counter) electrode 62B to complete the circuit. In measurement apparatus 40A, acquisition module 46A comprises a lock-in amplifier, which can obtain measurement data 50 (FIG. 1) based on one or more electrical characteristics (e.g., impedance, capacitance, etc.) of the electrical circuit using any solution.

Operation of management program 30 and measurement apparatus 40 is further discussed in the co-pending U.S. patent application Ser. No. 11/670,464 (Attorney Docket No. APPL-0004), filed on 2 Feb. 2007, and entitled “Electrode cleaning using electrical pulse”, which is hereby incorporated by reference. However, it is understood that some of the various modules/components of management program 30 (FIG. 1) and/or measurement apparatus 40 (FIG. 1), 40A can be implemented independently, combined, and/or not implemented. For example, in embodiments of the invention, management program 30 includes only monitoring module 32 (FIG. 1), measurement apparatus 40 does not include a conditions module 48 (FIG. 1), and/or the like. Additionally, is understood that management program 30 and/or measurement apparatus 40, 40A may include additional modules/components and/or functionality not shown.

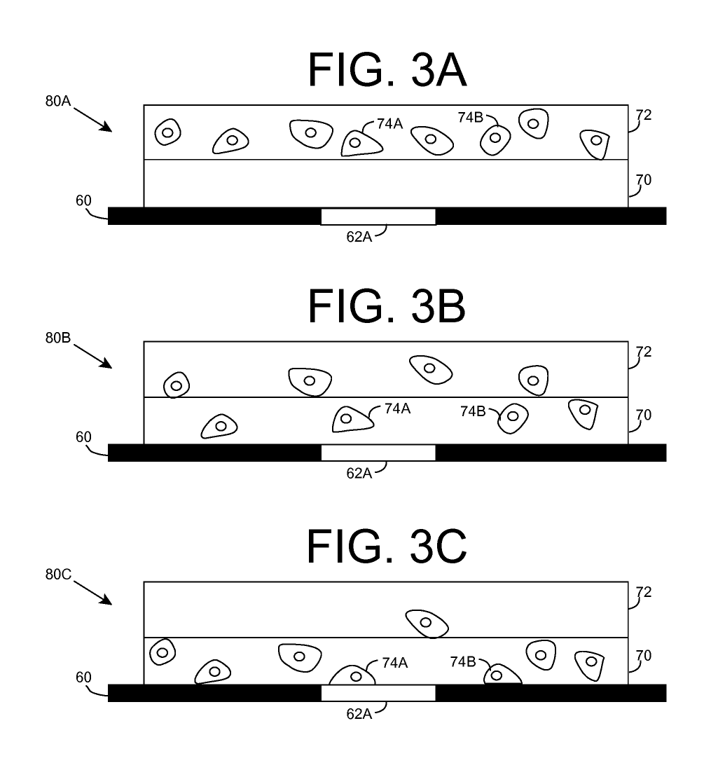

In any event, aspects of the invention provide solutions for electrically measuring the invasive movement of cells using measurement apparatus 40 (FIG. 1). Invasive cell movement, or cell invasion, occurs when the cells penetrate a medium (e.g., a gel). For example, FIGS. 3A-C show a series of cross-sectional views 80A-C of a well during an illustrative experiment to electrically measure the invasive movement of cells, such as cells 74A-B, according to an embodiment of the invention. Referring to FIGS. 1 and 3A-C, in order to perform the illustrative experiment, a gel layer 70 is formed on substrate 60 and over electrode 62A. Gel layer 70 can comprise any type of gel. For example, gel layer 70 can comprise a basement membrane protein, collagen, agarose, gelatin, or the like. To this extent, gel layer 70 can comprise any type of material that includes proteins and/or polysaccharides capable of forming a gel. Similarly, gel layer 70 can comprise a fibrin gel that is produced from fibrinogen with thrombin or a polyacrylamide gel, in which chemical cross-linking agent(s) is/are used to promote the gel formation.

Gel layer 70 can be formed using any solution. For example, a liquid can be added to the well using any solution, and gel layer 70 can be formed from the liquid. A thickness of gel layer 70 can be reproduced by regulating a volume and extent of the liquid added to the well. Further, to define a thickness, a form for casting can be utilized, for example, a cover slip having spacers over electrode 62A, which can be removed after gel layer 70 has set. Still further, the liquid could be allowed to flow by capillary action beneath a flat surface where the gel would then form. Even further, gel layer 70 can include a membrane having pores through which cells can travel, and which is coated with a gel to form gel layer 70.

The liquid can be encouraged to form a gel using any solution. To this extent, conditions module 48 can include a temperature device, which under operation of environment module 38, maintains a temperature within the well at a temperature that causes the liquid to gel and form gel layer 70. Further, conditions module 48 and/or a human user 16 could add an agent to promote the formation of gel layer 70 by the liquid. Still further, gel layer 70 can be formed apart from measurement apparatus 40 and deposited within the well.

In the experiment illustrated by views 80A-C, gel layer 70 can be evaluated for its influence on a migration of cells 74A-B. To this extent, gel layer 70 can comprise a compound that is being evaluated for its ability to attract cells 74A-B (e.g., a chemo-attractant) and/or its ability to interfere with the migration of cells 74A-B. The solution that forms gel layer 70 can comprise the compound being evaluated. Additionally, conditions module 48 (FIG. 1) and/or a human user 16 (FIG. 1) can add a compound, which is being evaluated for an influence on cell 74A-B migration, to gel layer 70. In this case, the compound can be added before, during, and/or after the solution has formed gel layer 70 using any solution.

The compound can be substantially uniformly distributed across gel layer 70. Alternatively, gel layer 70 can have a gradient composition of the compound. In the latter case, a source for the compound can be located below gel layer 70, e.g., within substrate 60, and the compound can diffuse into gel layer 70 to set up the gradient composition. When evaluating a compound for its influence on cell migration, it is understood that a control well can also be prepared and evaluated, in which gel layer 70 is the same, except for the presence of the compound. Additionally, it is understood that one or more additional compounds not being evaluated can be added/included in gel layer 70. For example, gel layer 70 can include a balanced salt solution, complete culture medium, and/or other solutions that are compatible with cells 74A-B. One or more of these compounds can be included, for example, to assist with the flow of electrical current through gel layer 70, to promote the movement of cells 74A-B, and/or the like.

Regardless, to evaluate gel layer 70, cells 74A-B can be added over gel layer 70 using any solution. For example, a culture medium 72 that includes cells 74A-B can be added over gel layer 70. Further, a surface of gel layer 70 can be inoculated with cells 74A-B. It is understood that various additional preparations may be performed prior to and/or during the experiment. For example, cleaning module 36 can direct voltage source 44 to electrically clean electrode 62A, environment module 38 can direct conditions module 48 to adjust/maintain one or more aspects of an environment within holding apparatus 42 (e.g., a temperature, pressure, lighting, and/or the like), and/or the like.

During the experiment, monitoring module 32 can direct voltage source 44 to apply an electrical signal to electrode 62A and can obtain measurement data 50 based on at least one property of the electrical signal from acquisition module 46. The electrical signal can be selected so as not to adversely impact a health of cells 74A-B. The experiment can last for any period of time, which can be automatically or manually defined based on cells 74A-B, gel layer 70, and/or the like. In an embodiment of the invention, an impedance of the electrical signal is measured. However, it is understood that any suitable property can be measured.

As illustrated by views 80B-C, during the experiment, cells 74A-B may penetrate and move into gel layer 70. Eventually, as shown in view 80C, one or more cells, such as cell 74A, will contact electrode 62A at a base of gel layer 70. Cell(s) 74A will begin to attach to the solid surface and interfere with the electrical current flow, thereby impacting the at least one property of the electrical signal being measured. Over time, more cells 74A may come in contact with electrode 62A as they move through gel layer 70, thereby increasing the impact on the at least one property. However, it is understood that when gel layer 70 includes a compound that acts as a repellant and/or otherwise substantially inhibits cell migration into gel layer 70, cells 74A-B may never come in contact with electrode 62A.

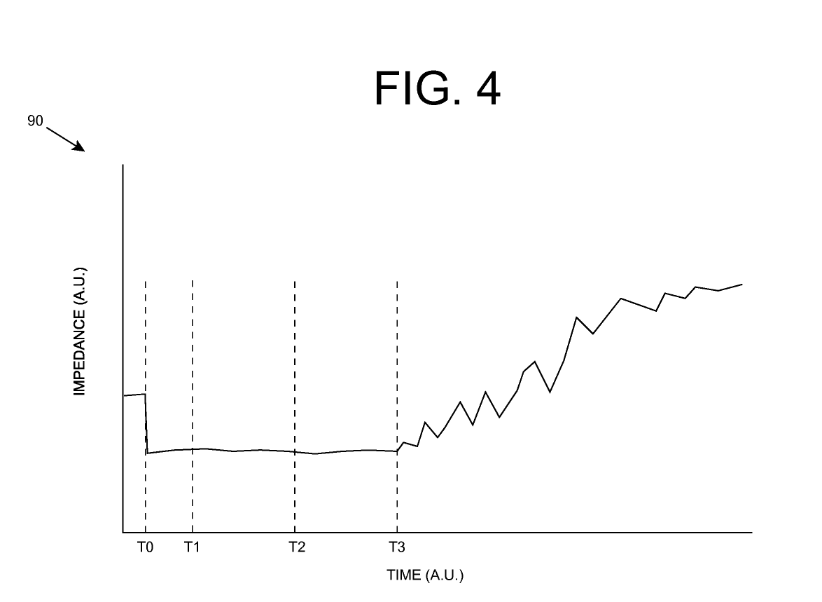

FIG. 4 shows a chart 90 for an illustrative experiment according to an embodiment of the invention. In this illustrative experiment, at time T0, cleaning module 36 (FIG. 1) can direct voltage source 44 (FIG. 1) to electrically clean electrode 62A (FIG. 3A), thereby restoring an impedance of electrode 62A. Time T1 can correspond to view 80A of FIG. 3A, at which point cells 74A-B are added above gel layer 70. Similarly, time T2 can correspond to view 80B of FIG. 3B, in which cells 74A-B are moving through gel layer 70, but have not yet reached electrode 62A. Finally, time T3 can correspond to view 80C of FIG. 3C, at which point a first cell 74A has contacted electrode 62A, thereby causing the measured impedance to rise.

Using measurement data 50 (FIG. 1) and/or chart 90, management program 30 (FIG. 1) and/or user 16 (FIG. 1) can evaluate an influence of a compound on cell migration using any solution. For example, a difference between times T1 and T3 can be used to determine if the compound may have slowed/hindered cell migration, enhanced cell migration, or had no substantial effect on cell migration. To this extent, the difference can be compared with a comparable difference for a control well, a known difference for other substances, and/or the like. Similarly, a length of time required for the impedance to reach a predetermined threshold (e.g., a maximum) can be used to evaluate the compound. Using this data, various attributes of the invasive movement of cells, such as a speed of the invasive movement, can be evaluated. Regardless, it is understood that measurement data 50 can be collected for multiple experiments including substantially similar and/or varying composition percentages and/or types (e.g., substantially uniform, graded, or the like) of the compound in gel layer 70 (FIG. 1).

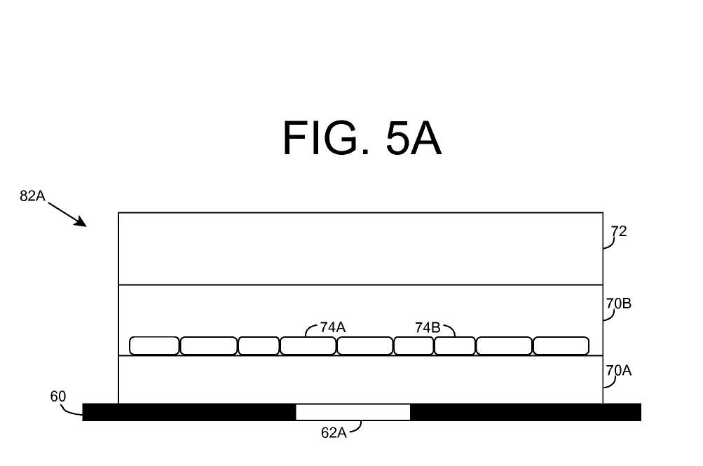

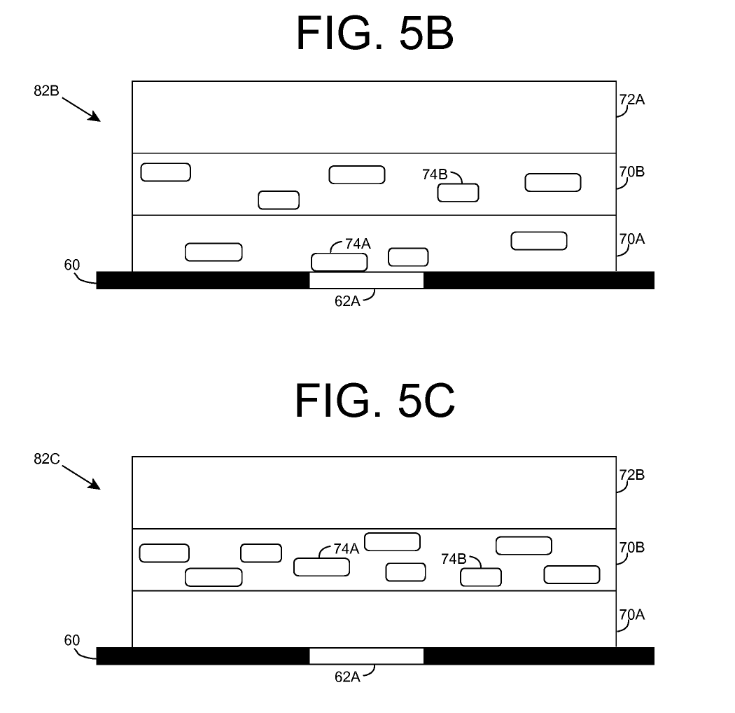

While FIGS. 3A-C illustrate an experiment in which an influence of a compound in gel layer 70 (FIG. 3A) on cell migration is evaluated, it is understood that various alternative experiments can be conducted. For example, FIGS. 5A-C show a series of cross-sectional views 82A-C of a well during another illustrative experiment to electrically measure the invasive movement of cells, such as cells 74A-B, according to another embodiment of the invention. As illustrated by view 82A, a first gel layer 70A can be formed on substrate 60 and electrode 62A using any solution. Additionally, cells 74A-B can be added to the well using any solution. As illustrated, cells 74A-B can be added above first gel layer 70A. However, it is understood that cells 74A-B could be added below first gel layer 70A and/or within first gel layer 70A.

Regardless, a second gel layer 70B can be formed over first gel layer 70A using any solution. Second gel layer 70B can comprise a substantially similar composition as first gel layer 70A. In this case, gel layers 70A-B collectively form a single gel layer having cells 74A-B therein. Additionally, it is understood that when cells 74A-B are added within and/or below first gel layer 70A, second gel layer 70B may not be used. Alternatively, second gel layer 70B may have a different composition than first gel layer 70A.

In any event, a medium 72 can be added over first gel layer 70A and/or second gel layer 70B using any solution. Medium 72 can include a compound that is being evaluated for an influence on cell 74A-B migration. To this extent, medium 72 can itself comprise the compound and/or a compound can be added to medium 72 using any solution. In the latter case, a separate control well can be similarly prepared, but with medium 72 not including the compound. Subsequently, the experiment can be implemented during which an electrical signal is applied to electrode 62A and at least one property of the electrical signal is measured as discussed herein.

Views 82B-C illustrate possible movement patterns for cells 74A-B. In view 82B, medium 72A does not attract cells 74A-B. As a result, cells 74A-B will randomly move about within gel layer(s) 70A-B. In this case, one or more cells 74A-B will eventually come in contact with electrode 62A at which point the at least one property of the electrical signal will be impacted. In view 82C, medium 72B and/or a compound therein, attracts cells 74A-B. As a result, cells 74A-B will generally move in an upward direction toward medium 72B. In this case, one or more cells 74A-B may not come in contact with electrode 62A.

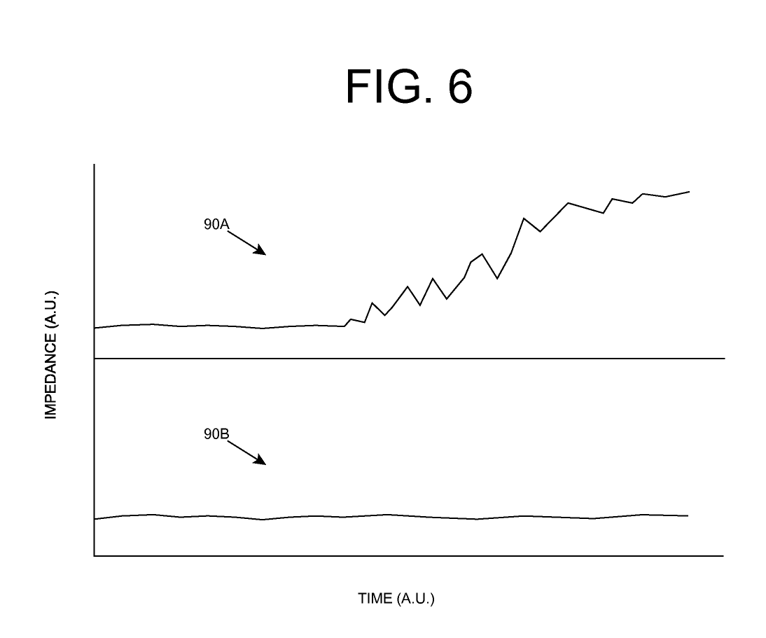

FIG. 6 shows a pair of charts 90A-B for another illustrative experiment according to an embodiment of the invention. Referring to FIGS. 5B-C and 6, chart 90A can correspond to view 82B in which cells 74A-B moved randomly throughout gel layers 70A-B, without being attracted to medium 72A and eventually attached to electrode 62A, thereby impacting a measured impedance. Chart 90B can correspond to view 82C in which cells 74A-B moved toward medium 72B and, as a result, failed to attach to electrode 62A. It is understood that charts 90A-B are only illustrative. For example, a compound that attracts cells 74A-B may delay the time by which cell(s) 74A-B come in contact with electrode 62A and/or a maximum impedance is reached. Regardless, using measurement data 50 (FIG. 1) and/or charts 90A-B, management program 30 (FIG. 1) and/or user 16 (FIG. 1) can correlate an influence of the compound on cell migration using any solution. Further, it is understood that additional experimental data can be obtained and used to evaluate the influence. For example, cells 74A-B can be stained and observed microscopically, cells 74A-B can be labeled with fluorescent compounds, and/or the like.

While shown and described herein as a method and system for electrically measuring invasive cell movement, it is understood that the invention further provides various alternative embodiments. For example, in one embodiment, the invention provides a computer program stored on a computer-readable medium, which when executed, enables a computer system to electrically measuring invasive cell movement. To this extent, the computer-readable medium includes program code, such as management program 30 (FIG. 1), which implements the process described herein. It is understood that the term “computer-readable medium” comprises one or more of any type of tangible medium of expression capable of embodying a copy of the program code (e.g., a physical embodiment). In particular, the computer-readable medium can comprise program code embodied on one or more portable storage articles of manufacture, on one or more data storage portions of a computing device, such as memory 22A (FIG. 1) and/or storage system 22B (FIG. 1), as a data signal traveling over a network (e.g., during a wired/wireless electronic distribution of the computer program), on paper (e.g., capable of being scanned and converted to electronic data), and/or the like.

In another embodiment, the invention provides a method of generating a system for electrically measuring invasive cell movement. In this case, a computer system, such as computer system 12 (FIG. 1), can be obtained (e.g., created, maintained, having made available to, etc.) and one or more programs/systems for performing the process described herein can be obtained (e.g., created, purchased, used, modified, etc.) and deployed to the computer system. To this extent, the deployment can comprise one or more of: (1) installing program code on a computing device, such as computing device 14 (FIG. 1), from a computer-readable medium; (2) adding one or more computing devices to the computer system; and (3) incorporating and/or modifying one or more existing devices of the computer system, to enable the computer system to perform the process described herein.

As used herein, it is understood that “program code” means any set of statements or instructions, in any language, code or notation, that cause a computing device having an information processing capability to perform a particular function either directly or after any combination of the following: (a) conversion to another language, code or notation; (b) reproduction in a different material form; and/or (c) decompression. To this extent, program code can be embodied as any combination of one or more types of computer programs, such as an application/software program, component software/a library of functions, an operating system, a basic I/O system/driver for a particular computing, storage and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of electrically measuring invasive cell movement, the method comprising:
adding cells over a first gel layer in a well, the well including a substrate having an electrode;
applying an electrical signal to the electrode; and
measuring at least one property of the electrical signal.

2. The method of claim 1, further comprising forming the first gel layer on the substrate.

3. The method of claim 2, the forming including adding a compound to the first gel layer, the compound being evaluated for an influence on a migration of the cells.

4. The method of claim 2, the forming including:
adding a liquid to the well; and
forming the first gel layer from the liquid.

5. The method of claim 2, the forming including coating a membrane with a gel.

6. The method of claim 1, the adding including adding a culture medium including the cells over the first gel layer.

7. The method of claim 1, the adding including inoculating a surface of the first gel layer with the cells.

8. The method of claim 7, further comprising forming a second gel layer over the first gel layer after the adding.

9. The method of claim 8, further comprising adding a medium over the second gel layer.

10. The method of claim 9, further comprising adding a compound to the medium, the compound being evaluated for an influence on a migration of the cells.

11. A method of electrically measuring invasive cell movement, the method comprising:
adding a medium over a first gel layer and cells in a well, the well including a substrate having an electrode;
applying an electrical signal to the electrode; and
measuring at least one property of the electrical signal.

12. The method of claim 11, further comprising forming the first gel layer in the well.

13. The method of claim 12, further comprising adding cells to the well.

14. The method of claim 13, the added cells being under the first gel layer.

15. The method of claim 13, the added cells being within the first gel layer.

16. The method of claim 13, the added cells being above the first gel layer.

17. The method of claim 11, further comprising adding a second gel layer over the first gel layer and the cells prior to adding the medium.

18. The method of claim 11, the medium including a compound being evaluated for an influence on a migration of the cells.

19. A method of electrically evaluating an influence of a compound on cell migration, the method comprising:
adding a medium over a gel layer in a first well, the first well including a substrate having an electrode, one of the medium and the gel layer including cells and the other of the medium and the gel layer including the compound;
applying an electrical signal to the electrode; and
measuring at least one property of the electrical signal.

20. The method of claim 19, the at least one property comprising an impedance, the method further comprising correlating the influence with the impedance.

21. The method of claim 19, further comprising performing the adding, applying and measuring for a second well, wherein both of the medium and the gel layer in the second well do not include the compound.

22. The method of claim 21, further comprising correlating the influence with the at least one property of the electrical signals for the first well and the second well.
